(19) United States
(12) Patent Application Publication
(10) Pub. No.: US 2013/0057233 A1
(43) Pub. Date: Mar. 7, 2013

(54) POWER MANAGEMENT SYSTEM APPLIED TO A SATELLITE DOWN CONVERTER AND METHOD THEREOF

(71) Applicants: Kuang-Yu Hsu, Taoyuan County (TW); Tung-Hung Wang, Taichung City (TW)

(72) Inventors: Kuang-Yu Hsu, Taoyuan County (TW); Tung-Hung Wang, Taichung City (TW)

(21) Appl. No.: 13/270,238

(22) Filed: Oct. 11, 2011

(30) Foreign Application Priority Data
Sep. 2, 2011 (TW) 100131675

(51) Int. Cl. G05F 1/46

(52) U.S. Cl. 323/234

(57) ABSTRACT

A power management system applied to a satellite down converter includes a direct current voltage/direct current voltage converter and a detector. The direct current voltage/direct current voltage converter is used for receiving a signal of at least one set-top box. The detector is used for receiving the signal of the at least one set-top box, and generating a control signal to the direct current voltage/direct current voltage converter and a low noise main circuit according to the signal of the at least one set-top box. The low noise main circuit turns off circuits not in use within the low noise main circuit temporarily according to the control signal, and the direct current voltage/direct current voltage converter adjusts a current and/or a voltage generated by the direct current voltage/direct current voltage converter according to the control signal and/or the circuits temporarily not in use within the low noise main circuit.

### BACKGROUND OF THE INVENTION

1. Field of the Invention

The present invention is related to a power management system and method thereof, and particularly to a power management system and method thereof that can be applied to a satellite down converter.

2. Description of the Prior Art

In the prior art, a detector of a satellite down converter can generate a control signal to turn off circuits not in use within a low noise main circuit of the satellite down converter temporarily according to a signal of a set-top box, and a direct current (DC) voltage/direct current (DC) voltage converter of the satellite down converter can generate current and a voltage required by the low noise main circuit according to the signal of the set-top box after the detector and the DC voltage/DC voltage converter receives the signal of the set-top box.

However, the DC voltage/DC voltage converter does not adjust the current and the voltage required by the low noise main circuit according to the control signal generated by the detector. In addition, in the prior art, the low noise main circuit does not completely turn off the circuits not in use within the low noise main circuit temporarily according to the control signal. Therefore, the DC voltage/DC voltage converter and the low noise main circuit may waste much unnecessary energy, resulting in the satellite down converter having lower energy conversion efficiency.

### SUMMARY OF THE INVENTION

An embodiment provides a power management system applied to a satellite down converter. The power management system includes a direct current (DC) voltage/direct current (DC) voltage converter and a detector. The DC voltage/DC voltage converter is used for receiving a signal of at least one set-top box. The detector is used for receiving the signal of the at least one set-top box, and generating a control signal to the DC voltage/DC voltage converter and a low noise main circuit according to the signal of the at least one set-top box. The low noise main circuit turns off circuits not in use within the low noise main circuit temporarily according to the control signal, and the DC voltage/DC voltage converter adjusts a current and/or a voltage generated by the DC voltage/DC voltage converter according to the control signal and/or the circuits not in use within the low noise main circuit temporarily.

Another embodiment provides a power management method applied to a satellite down converter. The power management method includes a DC voltage/DC voltage converter receiving a signal of at least one set-top box; a detector generating a control signal to the DC voltage/DC voltage converter and a low noise main circuit according to the signal of the at least one set-top box; the low noise main circuit turning off circuits not in use within the low noise main circuit temporarily according to the control signal, and the DC voltage/DC voltage converter adjusting a current and/or a voltage generated by the DC voltage/DC voltage converter according to the control signal and/or the circuits not in use within the low noise main circuit temporarily.

The present invention provides a power management system applied to a satellite down converter and a power management method applied to a satellite down converter. The power management system and the power management method utilize a detector to generate and output a control signal to a DC voltage/DC voltage converter and a low noise main circuit according to a signal of at least one set-top box. Then, the DC voltage/DC voltage converter adjusts current and/or a voltage generated by the DC voltage/DC voltage converter according to the control signal and/or circuits not in use within the low noise main circuit temporarily. Therefore, compared to the prior art, the present invention can increase energy conversion efficiency of the satellite down converter by adjusting the current and/or the voltage generated by the DC voltage/DC voltage converter, and completely turning off the circuits not in use within the low noise main circuit temporarily.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a power management system applied to a satellite down converter according to an embodiment.

FIG. 2 is a diagram illustrating a power management system applied to a satellite down converter according to another embodiment.

FIG. 3 is a flowchart illustrating a power management method applied to a satellite down converter according to another embodiment.

FIG. 4 is a flowchart illustrating a power management method applied to a satellite down converter according to another embodiment.

### DETAILED DESCRIPTION

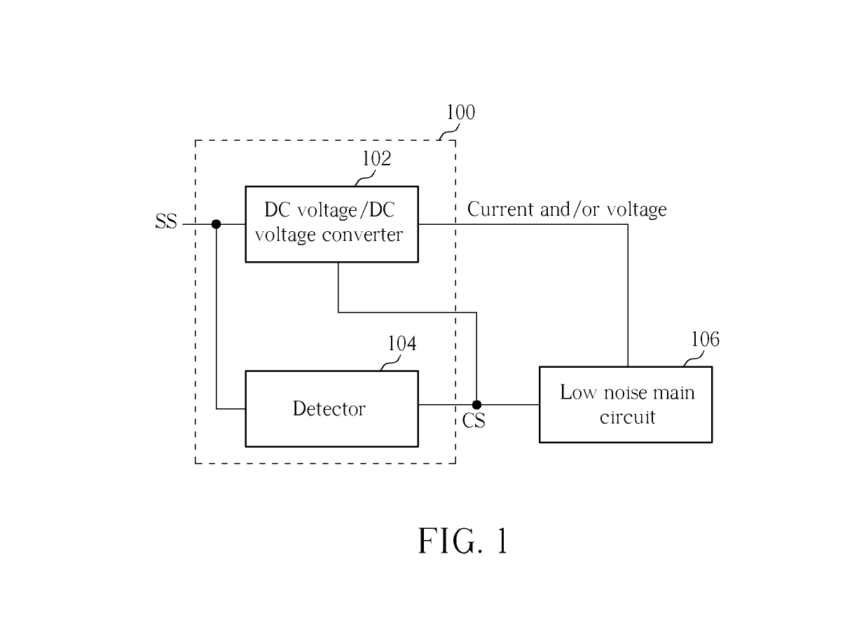

Please refer to FIG. 1. FIG. 1 is a diagram illustrating a power management system 100 applied to a satellite down converter according to an embodiment. The power management system 100 includes a direct current (DC) voltage/direct current (DC) voltage converter 102 and a detector 104. The DC voltage/DC voltage converter 102 is used for receiving a signal SS of a set-top box, and transmitting current and/or a voltage to a low noise main circuit 106. The signal SS of the set-top box is controlled by a user. But, the present invention is not limited to the DC voltage/DC voltage converter 102 only receiving a signal of one set-top box. That is to say, the DC voltage/DC voltage converter 102 can receive a signal of at least one set-top box. The detector 104 is used for receiving the signal SS of the set-top box, and generating a control signal CS to the DC voltage/DC voltage converter 102 and the low noise main circuit 106 according to the signal SS of the set-top box, where the low noise main circuit 106 turns off circuits not in use within the low noise main circuit 106 temporarily according to the control signal CS, and the DC voltage/DC voltage converter 102 adjusts the current and/or the voltage generated by the DC voltage/DC voltage converter 102 according to the control signal CS and/or the circuits not in use within the low noise main circuit 106 temporarily. In addition, the low noise main circuit 106 includes at least one low noise amplifier, at least one amplifier, at least one mixer, at least one local oscillator, at least one switch, and so on.

As shown in FIG. 1, the detector 104 generates the control signal CS according to an antenna polarization direction, a high-frequency band signal/a low-frequency band signal, or a digital satellite equipment control (DiSeqC) corresponding to the signal SS of the at least one set-top box. The detector 104 determines that the signal SS of the set-top box corresponds to the high-frequency band signal or the low-frequency band signal according to a 22 KHz tone, and the detector 104 determines the antenna polarization direction corresponding to the signal SS of the set-top box according to voltage variation of the signal SS of the set-top box.

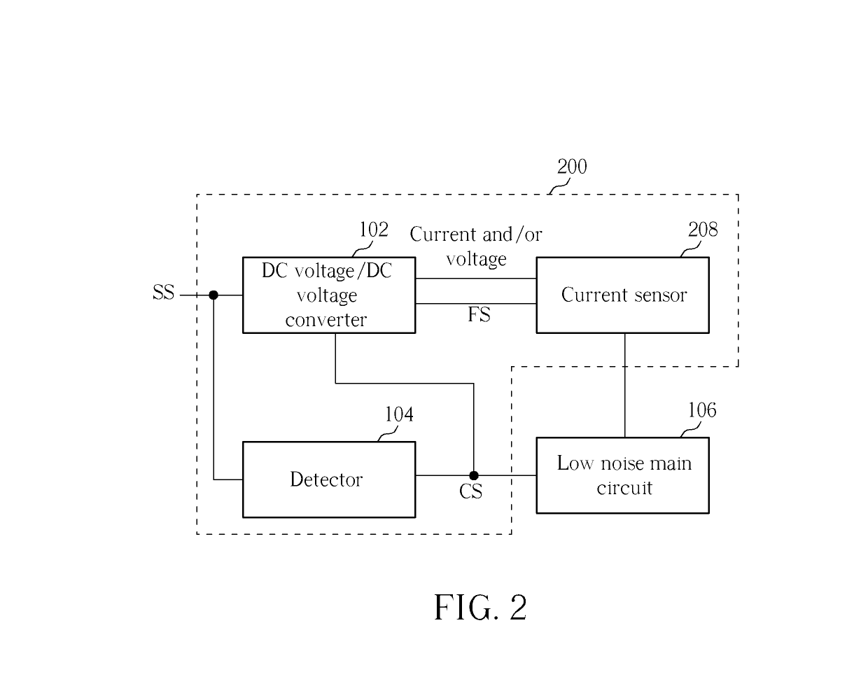

Please refer to FIG. 2. FIG. 2 is a diagram illustrating a power management system 200 applied to a satellite down converter according to another embodiment. A difference between the power management system 200 and the power management system 100 is that the power management system 200 further includes a current sensor 208. The current sensor 208 is coupled between the DC voltage/DC voltage converter 102 and the low noise main circuit 106 for generating a feedback signal FS to the DC voltage/DC voltage converter 102 according to current consumption of the low noise main circuit 106. The DC voltage/DC voltage converter 102 adjusts current and/or a voltage generated by the DC voltage/DC voltage converter 102 according to the feedback signal FS, a control signal CS, and/or circuits not in use within the low noise main circuit 106 temporarily. Further, subsequent operational principles of the power management system 200 are the same as those of the power management system 100, so further description thereof is omitted for simplicity.

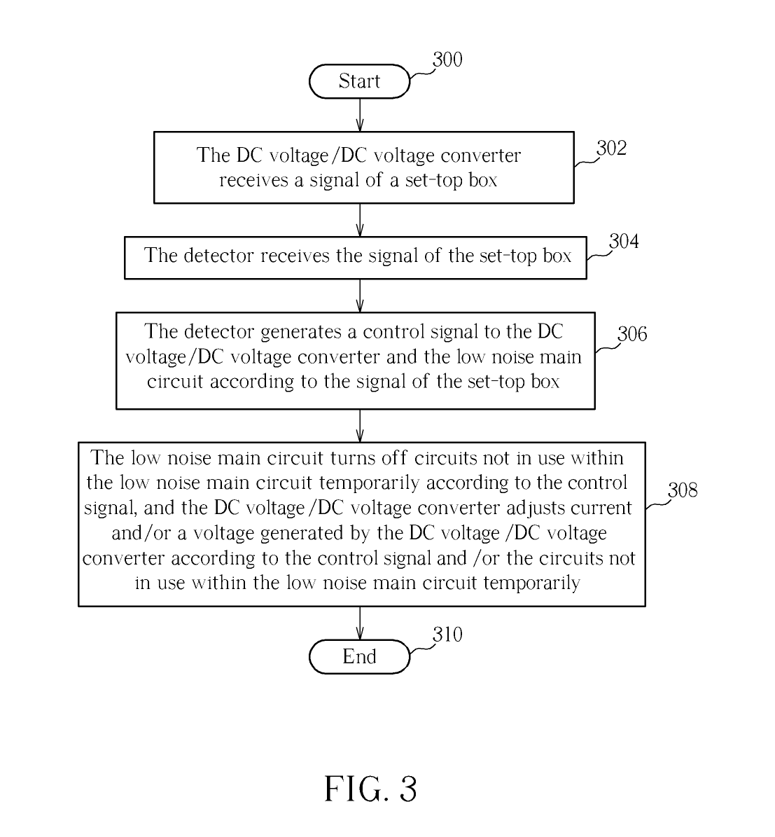

Please refer to FIG. 3. FIG. 3 is a flowchart illustrating a power management method applied to a satellite down converter according to another embodiment. The method in FIG. 3 is illustrated using the power management system 100 in FIG. 1. Detailed steps are as follows:

Step 300: Start.

Step 302: The DC voltage/DC voltage converter 102 receives a signal SS of a set-top box.

Step 304: The detector 104 receives the signal SS of the set-top box.

Step 306: The detector 104 generates a control signal CS to the DC voltage/DC voltage converter 102 and the low noise main circuit 106 according to the signal SS of the set-top box.

Step 308: The low noise main circuit 106 turns off circuits not in use within the low noise main circuit 106 temporarily according to the control signal CS, and the DC voltage/DC voltage converter 102 adjusts current and/or a voltage generated by the DC voltage/DC voltage converter 102 according to the control signal CS and/or the circuits not in use within the low noise main circuit 106 temporarily.

Step 310: End.

In Step 302, the signal SS of the set-top box is controlled by a user. In Step 306, the detector 104 generates the control signal CS according to an antenna polarization direction, a high-frequency band signal/a low-frequency band signal, or a digital satellite equipment control corresponding to the signal SS of the set-top box. The detector 104 determines that the signal SS of the set-top box corresponds to the high-frequency band signal or the low-frequency band signal according to a 22 KHz tone, and the detector 104 determines the antenna polarization direction corresponding to the signal SS of the set-top box according to voltage variation of the signal SS of the set-top box. In addition, the low noise main circuit 106 includes at least one low noise amplifier, at least one amplifier, at least one mixer, at least one local oscillator, at least one switch, and so on.

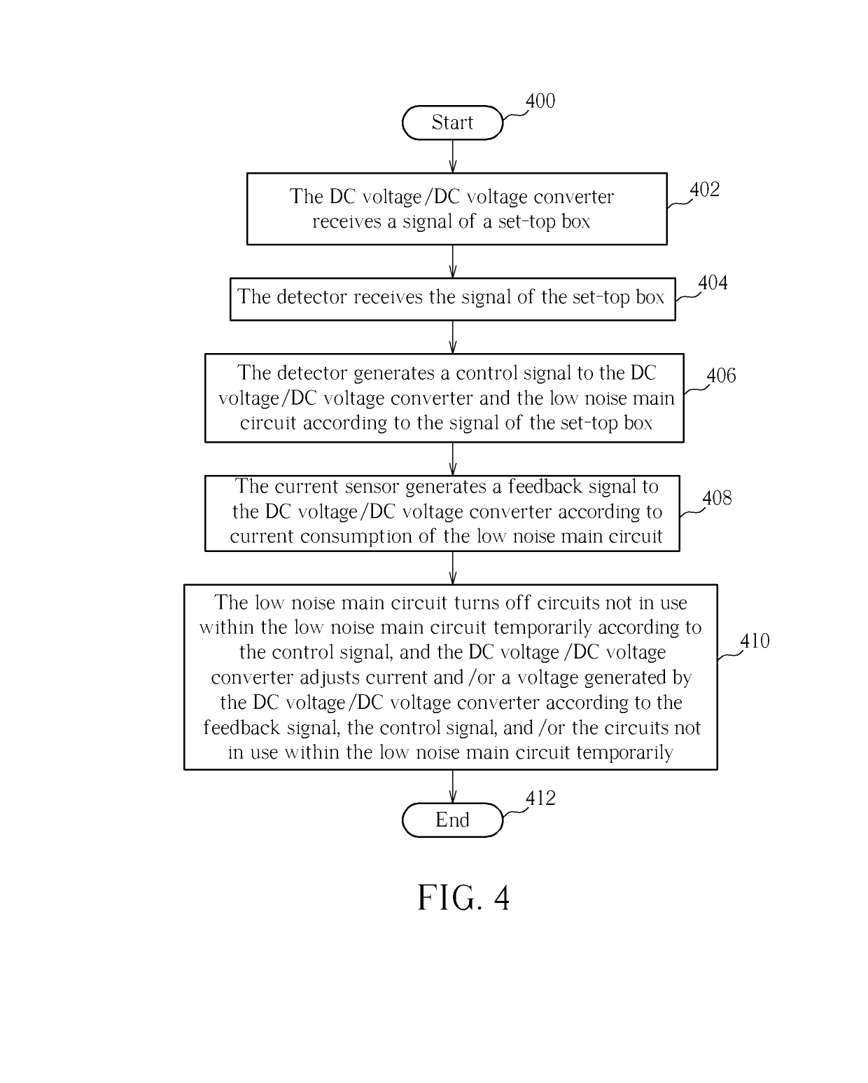

Please refer to FIG. 4. FIG. 4 is a flowchart illustrating a power management method applied to a satellite down converter according to another embodiment. The method in FIG. 4 is illustrated using the power management system 200 in FIG. 2. Detailed steps are as follows:

Step 400: Start.

Step 402: The DC voltage/DC voltage converter 102 receives a signal SS of a set-top box.

Step 404: The detector 104 receives the signal SS of the set-top box.

Step 406: The detector 104 generates a control signal CS to the DC voltage/DC voltage converter 102 and the low noise main circuit 106 according to the signal SS of the set-top box.

Step 408: The current sensor 208 generates a feedback signal FS to the DC voltage/DC voltage converter 102 according to current consumption of the low noise main circuit 106.

Step 410: The low noise main circuit 106 turns off circuits not in use within the low noise main circuit 106 temporarily according to the control signal CS, and the DC voltage/DC voltage converter 102 adjusts current and/or a voltage generated by the DC voltage/DC voltage converter 102 according to the feedback signal FS, the control signal CS, and/or the circuits not in use within the low noise main circuit 106 temporarily.

Step 412: End.

A difference between the embodiment in FIG. 4 and the embodiment in FIG. 3 is that in Step 408, the current sensor 208 can generate the feedback signal FS to the DC voltage/DC voltage converter 102 according to the current consumption of the low noise main circuit 106. Therefore, in Step 410, the DC voltage/DC voltage converter 102 can adjust the current and/or the voltage generated by the DC voltage/DC voltage converter 102 according to the feedback signal FS, the control signal CS, and/or the circuits not in use within the low noise main circuit 106 temporarily. Further, subsequent operational principles of the embodiment in FIG. 4 are the same as those of the embodiment in FIG. 3, so further description thereof is omitted for simplicity.

To sum up, the power management system applied to the satellite down converter and the power management method applied to the satellite down converter utilize the detector to generate and output the control signal to the DC voltage/DC voltage converter and the low noise main circuit according to the signal of at least one set-top box. Then, the DC voltage/DC voltage converter adjusts the current and/or the voltage generated by the DC voltage/DC voltage converter according to the control signal and/or the circuits not in use within the low noise main circuit temporarily. Therefore, compared to the prior art, the present invention can increase energy conversion efficiency of the satellite down converter by adjusting the current and/or the voltage generated by the DC voltage/DC voltage converter, and completely turning off the circuits not in use within the low noise main circuit temporarily.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power management system applied to a satellite down converter, the power management system comprising:
a direct current (DC) voltage/direct current (DC) voltage converter for receiving a signal of at least one set-top box; and
a detector for receiving the signal of the at least one set-top box, and generating a control signal to the DC voltage/DC voltage converter and a low noise main circuit according to the signal of the at least one set-top box;
wherein the low noise main circuit turns off circuits not in use within the low noise main circuit temporarily according to the control signal, and the DC voltage/DC voltage converter adjusts a current and/or a voltage generated by the DC voltage/DC voltage converter according to the control signal and/or the circuits not in use within the low noise main circuit temporarily.

2. The power management system of claim 1, further comprising:
a current sensor coupled between the DC voltage/DC voltage converter and the low noise main circuit for generating a feedback signal to the DC voltage/DC voltage converter according to current consumption of the low noise main circuit;
wherein the DC voltage/DC voltage converter adjusts the current and/or the voltage generated by the DC voltage/DC voltage converter according to the feedback signal.

3. A power management method applied to a satellite down converter, the power management method comprising:
a DC voltage/DC voltage converter receiving a signal of at least one set-top box;
a detector generating a control signal to the DC voltage/DC voltage converter and a low noise main circuit according to the signal of the at least one set-top box; and
the low noise main circuit turning off circuits not in use within the low noise main circuit temporarily according to the control signal, and the DC voltage/DC voltage converter adjusting a current and/or a voltage generated by the DC voltage/DC voltage converter according to the control signal and/or the circuits not in use within the low noise main circuit temporarily.

4. The power management method of claim 3, wherein the detector generating the control signal according to the signal of the at least one set-top box is the detector generating the control signal according to an antenna polarization direction corresponding to the signal of the at least one set-top box.

5. The power management method of claim 4, wherein the detector determines the antenna polarization direction corresponding to the signal of the at least one set-top box according to voltage variation of the signal of the at least one set-top box.

6. The power management method of claim 3, wherein the detector generating the control signal according to the signal of the at least one set-top box is the detector generating the control signal according to a high-frequency band signal/a low-frequency band signal corresponding to the signal of the at least one set-top box.

7. The power management method of claim 6, wherein the detector determines that the signal of the at least one set-top box corresponds to the high-frequency band signal or the low-frequency band signal according to a 22 KHz tone.

8. The power management method of claim 3, wherein the detector generating the control signal according to the signal of the at least one set-top box is the detector generating the control signal according to a digital satellite equipment control (DiSeqC) corresponding to the signal of the at least one set-top box.

9. The power management method of claim 3, further comprising:
a current sensor generating a feedback signal to the DC voltage/DC voltage converter according to current consumption of the low noise main circuit; and
the DC voltage/DC voltage converter adjusting the current and/or the voltage generated by the DC voltage/DC voltage converter according to the feedback signal.

10. The power management method of claim 9, wherein the detector generating the control signal according to the signal of the at least one set-top box is the detector generating the control signal according to an antenna polarization direction corresponding to the signal of the at least one set-top box.

11. The power management method of claim 10, wherein the detector determines the antenna polarization direction corresponding to the signal of the at least one set-top box according to voltage variation of the signal of the at least one set-top box.

12. The power management method of claim 9, wherein the detector generating the control signal according to the signal of the at least one set-top box is the detector generating the control signal according to a high-frequency band signal/a low-frequency band signal corresponding to the signal of the at least one set-top box.

13. The power management method of claim 12, wherein the detector determines that the signal of the at least one set-top box corresponds to the high-frequency band signal or the low-frequency band signal according to a 22 KHz tone.

14. The power management method of claim 9, wherein the detector generating the control signal according to the signal of the at least one set-top box is the detector generating the control signal according to a digital satellite equipment control (DiSeqC) corresponding to the signal of the at least one set-top box.
